(19) United States
(12) Patent Application Publication
(10) Pub. No.: US 2004/0085957 A1
(43) Pub. Date: May 6, 2004

(54) Apparatus and method for providing IP connectivity to mobile nodes during handover

(76) Inventor: Sanjeev Verma, Woburn, MA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/285,519

(22) Filed: Nov. 1, 2002

(51) Int. Cl. H04L 12/56

(52) U.S. Cl. 370/389

(57) ABSTRACT

The invention provides IP connectivity to mobile nodes by pre-establishing at least one virtual link between access routing devices and mapping a data flow relating to a mobile node being handed over from a first access routing device to a second access routing device to the at least one pre-established virtual link between the first and second access routing devices in accordance with predetermined conditions.

### BACKGROUND OF THE INVENTION

1. Field of the Invention

The present invention relates to providing IP connectivity to mobile nodes which are attached to an access network providing access to an Internet Protocol (IP) network and which are handed over from one access router to another.

2. Description of the Prior Art

A typical administrative domain of a mobile network operator consists of a number of access networks that are organized on the basis of access technology and/or geographical region. FIG. 1 shows such typical administrative domain. A mobile host (not shown) communicates with one or more access points (AP), sometimes referred to as base stations. The APs are connected to access routers (ARs) using a chosen transport option. The AR keeps track of AP mapping of the attached mobile hosts. The AR is the most peripheral node in the domain and provides the IP connectivity to the mobile hosts in the attached access network.

In case a mobile host moves across a cell border between adjacent access networks two handover procedures have to be performed. The first one is the handover procedure between radio network controllers (RNCs) of adjacent cell sites, each in a different access network, and the second one is the handover procedure between adjacent access routers, each serving a different access network. Both handover procedures cause delays so that delay requirements for real time applications may not be met. For example, for VoIP (Voice over Internet Protocol) the delay requirements are less than 100 ms to maintain a required QoS (Quality of Service)

A handover procedure between RNCs involves establishing a link between the RNCs which can create more than an 80 ms end-to-end delay. The WO 99/41925 discloses a method for reducing handover time delay between adjacent RNCs by partitioning the handover procedure. In particular, in the WO 99/41925 it is described that at least one candidate base station is determined to which a mobile node is likely to be handed over and an additional connection is set up from a network element of an access network to the candidate base station(s) before handover is executed.

The handover procedure between access routers (ARs) is also critical to delay requirements which will be described in the following.

Mobility within the realm of an AR is known as link-layer mobility. Mobility across ARs relies on a network layer protocol such as Mobile IP to provide wide-area mobility. For example, Mobile IP is described by C. Perkins in “Mobile IP”, IEEE Communications Magazine, May 2002. However, Mobile IP is not a suitable protocol for real-time applications due to signaling overhead, handover latency, and transient packet loss.

A fast handover/context transfer protocol has been recently proposed as an alternative to Mobile IP to accomplish fast handovers between access routers. For example, the fast handover/context transfer protocol is described by R. Koodil and C. Perkins in “Fast handovers and context transfers in mobile networks”, ACM Computer Communication Review, October 2001. The main motivation of this protocol is to support real-time applications like VoIP that has very stringent end-to-end delay requirements as mentioned above. There are two design points in the fast handover problem:

Latency due to IP address acquisitions and configuration subsequent has to be reduced.

Latency in forwarding IP packets to a new IP address of a mobile host must be reduced.

The fast handover/context transfer protocol consists of four major steps: target access router discovery, handshake between previous access router (PAR) and next access router (NAR), i.e. the access router to which a mobile node is handed over, to get the new IP address (IP connectivity), context transfer, and tunneling to forward a VOIP packet between PAR and NAR before packets start arriving at NAR from a correspondent node (CN) communicating with the mobile node (MN).

As mentioned before, the main goal of the fast handover/context transfer protocol is to minimize the handover time at the network layer. The handover delay timeline is shown in FIG. 2. FIG. 2 shows a time at which a handover of a mobile node from a PAR to an NAR is started, a time period required for link switching and a time period required for IP connectivity and packet reception following the link switching time period. With establishing the IP connectivity, the neighbor discovery procedure is completed and transmission from the mobile node to the NAR is possible. In this situation, when the PAR receives a binding update from the mobile node data packets may be tunneled from the PAR to the NAR. Furthermore, FIG. 2 shows a time at which a home agent HA in an access network of the NAR and the correspondent node CN receive a binding update message from the mobile node, and a time at which packets transmitted from the CN begin to arrive directly at the new IP address.

The experimental results described in “Fast handovers and context transfers in mobile networks” show that the “link-switching delay” contributes maximum to the end-to-end delay. The average value has been shown to be 85 msec. This leaves a very small error of margin in delay involved in forwarding packets from PAR to NAR. Also, the context transfer should be fast and reliable in order to establish the path from the CN to the NAR (new access router after handover).

FIG. 3 shows different components of the delay as mobile node hands-off from one AR (PAR) to the another AR (NAR). The delay involved in switching from one link to another, i.e. the link switching delay, overlaps with the delay involved in establishing the tunnel which is shown in FIG. 2 as “Forwarding from PAR to NAR established”. The tunnel is established once the handshake is over between PAR and NAR (Handshake Initiate (HI) and Handshake Ack (HACK)). As mentioned above, the forwarding of data from the PAR to the NAR starts when the PAR receives a “Fast” Mobile IPv6 Binding Update message from the mobile node. The performance requirement for real-time applications like VoIP can be given by:

d1+d2+d3<=100 msec

in which d1 is the time required for transmitting a data packet intended to be received by the MN from the CN to the PAR, d2 is the time required for handing over the MN from the PAR to the NAR, and d3 is the time required for transmitting the data packet from the NAR to the handed over MN.

As described above, according to the conventional handover solution between access routers a tunnel is created on demand for every session that has to be handed over to a next access router. Moreover, the conventional handover solution does not assume any QoS model and a best-effort network is used to tunnel packets from the PAR to the NAR. This can adversely impact the QoS for real-time services like VOIP

Moreover, no special effort is made to transport error sensitive information carried during context transfer. The information carried during context can be lost due to congestion (assuming UDP (User Datagram Protocol) at transport layer) in the best-effort network. Probably some sort of reliability can be provided by transporting context by using TCP (Transmission Control Protocol) protocol. However, it can delay the context transfer if data has to be retransmitted several times due to congestion in the network.

### SUMMARY OF THE INVENTION

The present invention provides improvement over the conventional handover procedure between access routers.

The invention provides an improvement over the conventional fast handover/context transfer protocol. According to the present invention, by using advance traffic engineering techniques like MPLS/DiffServ QoS with the fast handover/context transfer protocol, seamless and reliable QoS can be attained.

### BRIEF DESCRIPTION OF THE DRAWINGS

FIG. 1 shows a diagram illustrating a conventional network architecture.

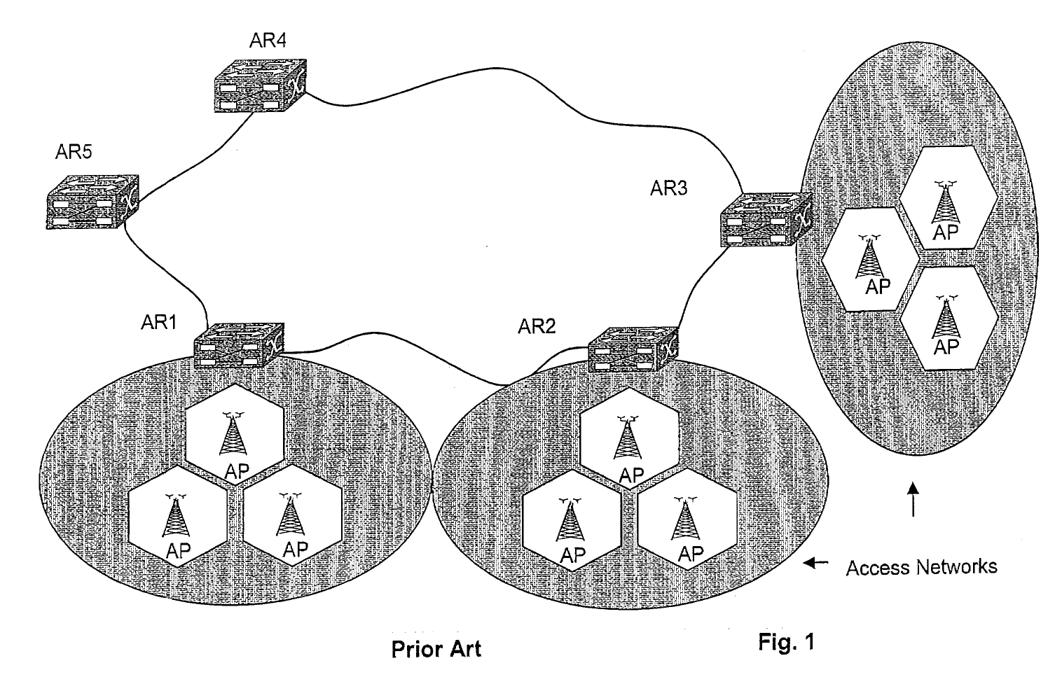

FIG. 2 shows a time chart illustrating a conventional handover delay.

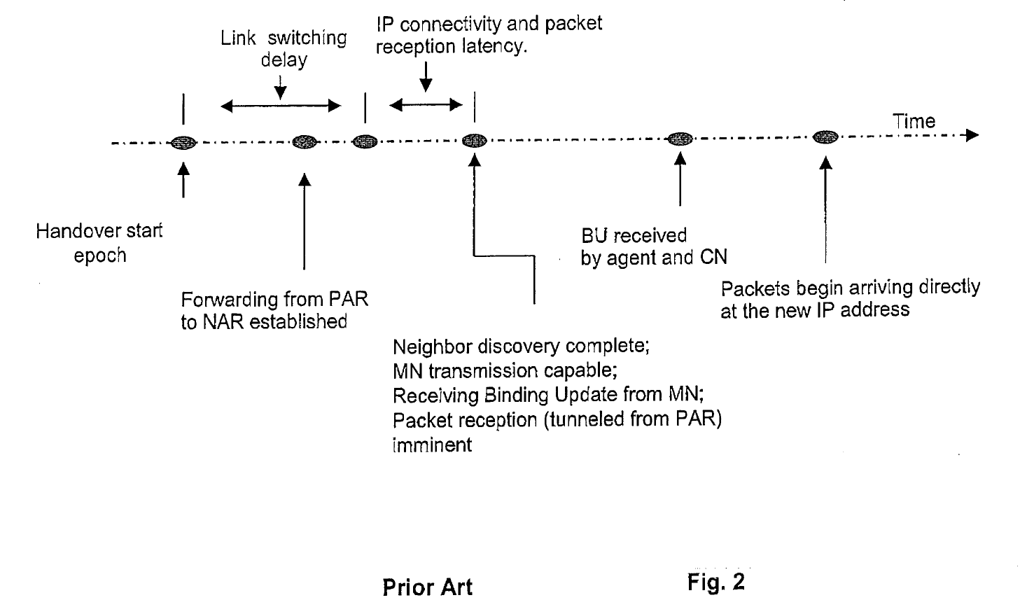

FIG. 3 shows a diagram illustrating an end-to-end delay for a real-time service.

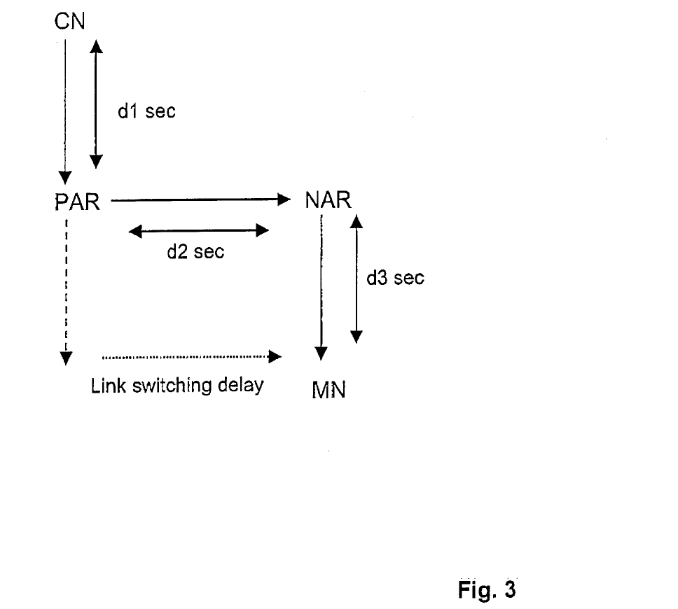

FIG. 4 shows a diagram illustrating a network architecture according to an embodiment of the present invention.

FIG. 5 shows a diagram illustrating an architecture of an access router according to an embodiment of the present invention.

### DESCRIPTION OF THE PREFERRED EMBODIMENTS OF THE INVENTION

In view of link switching contributing a maximum (85 msec) to the handover delay d2 as mentioned above, it is desirable to complete the tunnel establishment and forwarding of packets much before that in order to achieve a desired QoS. The establishment of a tunnel on per-flow basis according to the prior art is not desirable.

Furthermore, a number of VoIP calls handover from one access network to a neighboring access network. The volume of traffic handed over from one access network to another depends on the time of the day. For, example during business hours substantial real-time traffic travels between neighboring access networks. It makes sense to have pre-configured tunnels between neighboring ARs instead of creating a tunnel for each flow.

Moreover, context transfer carries an important piece of information (security context, QoS context etc.) from one AR (PAR) to another AR (NAR). This information plays an important role in establishing the connection from CN to the new location (NAR). Hence, this information should be reliably transported.

In order to meet the above requirements, according to the present invention, IP connectivity is provided to mobile nodes by pre-establishing at least one virtual link between ARs and mapping a data flow relating to a mobile node being handed over from a first AR (PAR) to a second AR (NAR) to the at least one pre-established virtual link between the first and second ARs in accordance with predetermined conditions.

According to an embodiment of the present invention, an MPLS (Multi Protocol Label Switching) and DiffServ (Differentiated Services) QoS model with fast handover/context transfer is used to accomplish seamless QoS for real-time services like VoIP. MPLS which is described by E. Rosen et al. in “Multi Protocol Label Switching Architecture”, RFC3031, January 2001, is a technology that substitutes conventional packet forwarding within a network, or part of a network, with a faster operation of label lookup and switching. Conventional forwarding is based on the network layer information in the packet header, which is analyzed at each hop. In an MPLS based network segment, the network layer header is analyzed only at the entry and exit points of the network. As a result of the analysis at the entry point, the packet is assigned to a specific forwarding equivalence class (FEC) and the FEC is encoded into the packet's extended header as a short fixed-length label. At the subsequent hops within the segment, no further analysis such as packet classification is performed, instead the label is used as an index into a lookup table that specifies the next-hop and the new label value. The path taken by a packet belonging to an FEC, inside the MPLS segment, is referred to as the Label Switched Path (LSP) for that FEC. The internal nodes that perform MPLS switching are called label switching routers (LSRs), while the routers located at the boundaries of the segments are usually referred to as label edge routers (LER). Besides making a fast forwarding decision, MPLS has other significant advantages. For example, MPLS allows to differentiate packets based on their entry point into the segment, and to increase the richness of the classification criteria and FEC mapping at the LER without any impact on the LSRs. Furthermore, LSPs can be either signaled or engineered to provide QoS guarantees.

Differentiated Services (DiffServ), which is described by S. Blake et al. in “An Architecture for Differentiated Services”, RFC2475, has emerged as the service model to provide QoS in the Internet. DiffServ does no per-flow admission control or signaling, and routers do not maintain per-flow state. Routers merely implement a suite of priority-like scheduling and buffering mechanisms and apply based on a DS field in packet headers.

According to the invention, MPLS along with DiffServ QoS model may be combined to achieve certain traffic engineering and QoS objectives in order to meet certain performance requirements.

According to an embodiment of the invention, fast handover/context transfer is modified by using MPLS and DiffServ to provide seamless QoS.

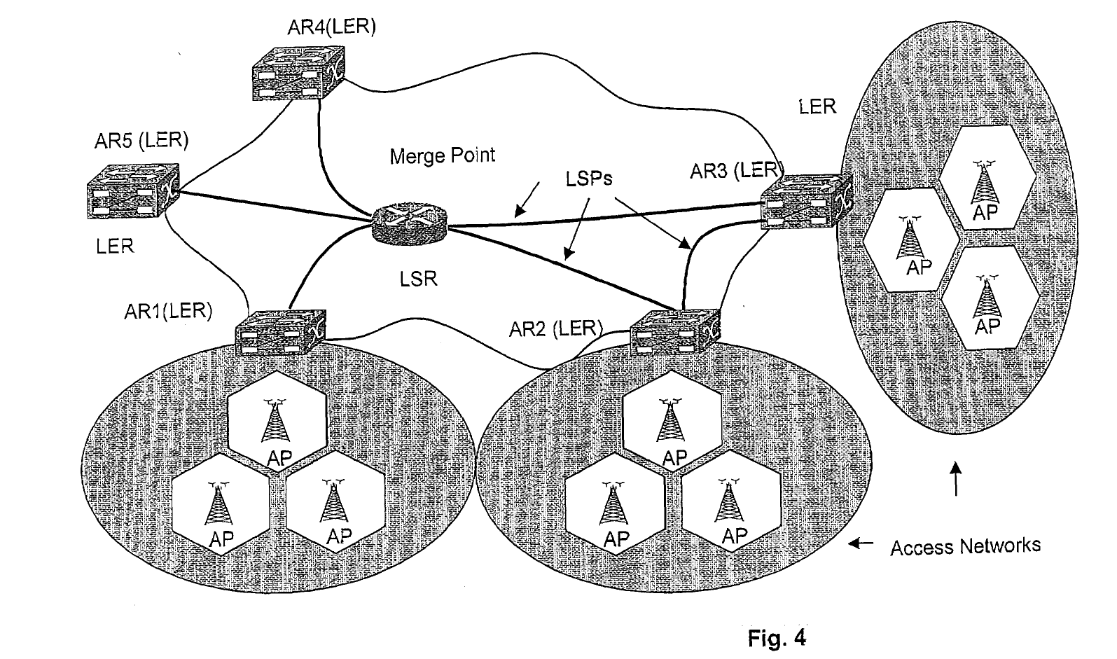

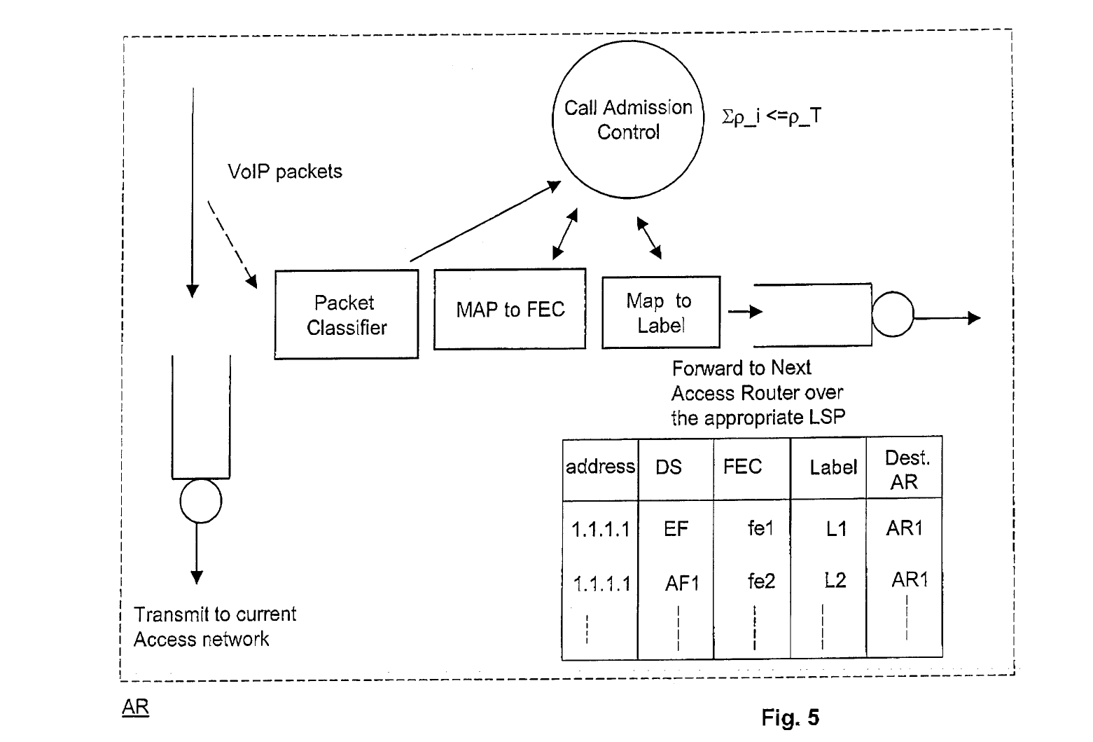

FIG. 4 shows a network architecture where the administrative domain under consideration uses MPLS with traffic engineering as the transport option. All the access routers ARs in the domain function as LERs which are linked to a common LSR. The architecture of an access router functioning as LER is shown in FIG. 5.

According to an embodiment, all IPv6 flows carry traffic characteristics or a traffic indicator with an IP address of the access router in the destination option header field. For example, Ipv6 is described by S. Deering and R. Hinden in “Internet Protocol, Version 6 (Ipv6) Specification”, RFC2460, December 1998. In Ipv4 RSVP (Resource Reservation Protocol) may be used. This way the AR can keep track of the QoS requirements of different flows going through it. This information can be useful in making call admission control decisions and mapping handover flows to the appropriate tunnel.

As shown in FIG. 5, in case of a handover situation VoIP packets arriving at the AR are forwarded to a packet classifier and are subjected to call admission control. The packets may be mapped to a specific forwarding equivalence class FEC, e.g. fe1, fe2, and the FEC is encoded into the extended header of the packet as a short fixed-length label. Then, the packets are mapped to a specific label, e.g. L1, L2, and are forwarded to the NAR over the appropriate LSP.

A number of LSPs can be configured between ARs to carry data and control packets. According to an embodiment, all control traffic, i.e. signaling and context transfer, is mapped to the LSP providing EF (Expedited Forwarding) service (L1 in FIG. 5), keeping in mind the importance (error-sensitiveness) of these traffic in establishing the path once the handover to the NAR is over.

Moreover, a number of LSPs can be configured between neighboring ARs for different real-time services such as VoIP, Streaming, etc. The bandwidth of these LSPs can be engineered based on the volume of real-time traffic going across ARs. This value may depend on the time of day. For example, service providers may like to reserve substantial bandwidth during peak business hours. The bandwidth can be either statically configured, e.g. through a management port, or dynamically configured using RSVP or CR-LDP (Constraint based Routing using Label Distribution Protocol).

The available bandwidth along an LSP tunnel can be measured by using a well known technique, e.g. Packet-Pair technique by Keshav. All flows mapped to the tunnel can be identified based on a DS (Differentiated Services) field (EF or AF1 in FIG. 5) or flow label field (L1 or L2 in FIG. 5) carried in the packet headers. The traffic parameters carried in the destination extension header can be combined to make an appropriate call admission control decision at the tunnel entry point node, i.e. the AR. For example, the sum of an average sustainable rate p_i should be less than the configured bandwidth of the tunnel p_T. The individual flows are identified by the flow-label field carried in the packet header. If the addition of a new flow causes the total average rate to exceed the configured tunnel bandwidth, then a request for additional bandwidth along the tunnel should be made.

According to a further embodiment, the flows mapped to an LSP are appropriately shaped at the AR router to achieve certain delay characteristics across the LSP.

Furthermore, once the handover to the NAR is complete, i.e., a new path is established between CN and NAR, an appropriate signal, e.g. an ICMP (Internet Control Message Protocol) message, may be sent by the NAR to the call admission control block in the PAR to remove the reservation and free resources in the LSP.

signaling for the fast handover/context transfer according to an embodiment of the invention is similar to that proposed in “Fast handovers and context transfers in mobile networks”, except that in the embodiment the flow is mapped to the appropriate LSP (which mapping may involve packet classification in conjunction with call admission control) by the PAR when the PAR receives the “Fast” Mobile IPv6 Binding Update message from the mobile node.

As described above, according to an embodiment of the invention, all data flows comprise a destination option extension header to carry the traffic parameters of the individual IPv6 flows to a tunnel entry point node (AR). This node implements an appropriate call admission control and traffic shaping scheme taking into consideration the traffic characteristics of the individual IPv6 flows to be mapped to the tunnel. This node may also implement the appropriate mechanism (RSVP signalling or Packet-Pair technique) to measure the available bandwidth along an LSP. The tunnel endpoint (NAR) may also implement an appropriate mechanism to calculate the available bandwidth and send the results to the tunnel entry point node (PAR). In order to map the flows to the appropriate LSPs the AR implements packet classification algorithms.

According to the invention, the handoff procedure is partitioned. Virtual links are pre-established and are either activated by the router automatically or under certain conditions, or manually provisioned by the operator, for specific types of traffic requiring a certain level of QoS. Data packets of a data flow may be required to carry in the IP address field identifying the access router a type of traffic indicator so that an access router can identify data flow qualifying for use of these links. The deployment of these links under certain conditions may occur under varying conditions, for example at certain times of the day, during business hours when traffic is heavy, or when traffic flow over a network exceeds a certain level, or optionally, or addtionally, traffic flow of a certain type exceeds a certain level. Also, the amount of resources may be dynamically allocated to the pre-established links initially and when required. The pre-established links may also allow for handoff functions to be completed in adequate time to maintain required level of QoS for real time applications.

In order to further reduce delay, the present invention may be employed complementarily to the RNC handover solution proposed in the WO 99/41925.

It is to be understood that the above description is illustrative of the invention and is not to be construed as limiting the invention. Various modifications and applications may occur to those skilled in the art without departing from the true spirit and scope of the invention as defined by the appended claims.

1. An access routing device (AR) for providing IP connectivity to mobile nodes, comprising:
means for pre-establishing at least one virtual link (LSP) with at least one other access routing device; and
means for mapping a data flow relating to a mobile node being handed over to the other access routing device to the at least one virtual link.

2. An access routing device according to claim 1, in which the mapping means is arranged to map the data flow to the virtual link in accordance with a traffic indicator contained in the data flow.

3. An access routing device according to claim 1, in which the mapping means is arranged to map the data flow to the virtual link in accordance with network conditions.

4. An access routing device according to claim 1, in which the mapping means is arranged to map the data flow to the virtual link in accordance with a type of the data.

5. An access routing device according to claim 1, further comprising means for allocating resources to the pre-established links.

6. An access routing device according to claim 5, further comprising means for removing the allocated resources when handover to the other access routing device is completed.

7. An access routingn device according to claim 1, in which the pre-established means is arranged to use MPLS mechanisms for establishing the at least one virtual link.

8. An access routing decvice according jto claim 1, in which the pre-establishine means is arranged to use Differentiated Services mechanisms for establishing the at least one virtual link.

9. A mobile node for connecting to an access routing device according to claim 2, comprising means for including the traffic indicator in the data flow towards the access routing device.

10. An access network for providing access to an IP network comprising an access routing device according to any one of claims 1 to 8.

11. A method of providing IP connectivity to mobile nodes, comprising the steps of:
pre-establishing at least one virtual link (LSP) between access routing devices (ARs); and
mapping a data flow relating to a mobile node being handed over from a first access routing device (PAR) to a second access routing device (NAR) to the at least one pre-established virtual link between the first and second access routing devices in accordance with predetermined conditions.

12. A method according to claim 11, further comprising the step of including a traffic indicator in a data flow towards an access routing device, and in which the data flow is mapped to the virtual link in accordance with the traffic indicator contained in the data flow.

13. A method according to claim 11, in which the data flow is mapped to the virtual link in accordance with network conditions.

14. A method according to claim 11, in which the data flow is mapped to the virtual link in accordance with a type of the data.

15. A method according to claim 11, further comprising the step of allocating resources to the pre-established links.

16. A method according to claim 15, further comprising the step of removig the allocated resources when handover to the second access routing device is completed.

17. A mehtod according to claim 11, in which the links are pre-established by using MPLS mechanisms.

18. A method according to claim 11, in which the links are pre-established by using Differentiated Services mechanisms.

19. An access routing device for providing IP connectivity to mobile nodes, comprising:
means for pre-establishing at least one virtual link with at least one other access routing device; and
means for mapping a data flow relating to a mobile node being handed over to the other access routing device to the at least one virtual link.

20. An access routing device according to claim 19, in which the means for mapping maps the data flow to the at least on virtual link in accordance with a traffic indicator contained in the data flow.

21. An access routing device according to claim 19, in which the means for mapping maps the data flow to the virtual link in accordance with network conditions.

22. An access routing device according to claim 19, in which the means for mapping maps the data flow to the virtual link in accordance with a type of the data.

23. An access routing device according to claim 19, comprising means for allocating resources to the pre-established links.

24. An access routing device according to claim 23, comprising means for removing the allocated resources when handover to the other access routing device is completed.

25. An access routing device according to claim 19, in which means for pre-establishing uses an MPLS mechanism for establishing the at least one virtual link.

26. An access routing device according to claim 19, in which the means for pre-establishing uses a Differentiated Services mechanisms for establishing the at least one virtual link.

27. A mobile node for connecting to an access routing device according to claim 20, comprising means for including the traffic indicator in the data flow towards the access routing device.

28. An access network for providing access to an IP network comprising an access routing device according claim.

29. A method of providing IP connectivity to mobile nodes, comprising the steps of:
pre-establishing at least one virtual link between access routing devices; and
mapping a data flow relating to a mobile node being handed over from a first access routing device to a second access routing device to the at least one pre-established virtual link between the first and second access routing devices in accordance with predetermined conditions.

30. A method according to claim 29, comprising the step of including a traffic indicator in a data flow towards an access routing device, and in which the data flow is mapped to the virtual link in accordance with the traffic indicator contained in the data flow.

31. A method according to claim 29, wherein the data flow is mapped to the virtual link in accordance with network conditions.

32. A method according to claim 29, in which the data flow is mapped to the virtual link in accordance with a type of the data.

33. A method according to claim 29, comprising the step of allocating resources to the pre-established links.

34. A method according to claim 33, comprising the step of removing the allocated resources when handover to the second access routing device is completed.

35. A method according to claim 29, wherein the links are pre-established by using an MPLS mechanism.

36. A method according to claim 29, wherein the links are pre-established by using Differentiated Services mechanism.

37. An access network for providing access to an IP network comprising an access routing device according to claim 2.

38. An access network for providing access to an IP network comprising an access routing device according to claim 3.

39. An access network for providing access to an IP network comprising an access routing device according to claim 4.

40. An access network for providing access to an IP network comprising an access routing device according to claim 5.

41. An access network for providing access to an IP network comprising an access routing device according to claim 6.

42. An access network for providing access to an IP network comprising an access device according to claim 7.

43. An access network for providing access to an IP network comprising an access routing device according to claim 8.
